(19) United States
(12) Patent Application Publication
(10) Pub. No.: US 2016/0374506 A1
(43) Pub. Date: Dec. 29, 2016

(54) LID SITTER

(71) Applicant: Khanh M. Bui, San Leandro, CA (US)

(72) Inventor: Khanh M. Bui, San Leandro, CA (US)

(21) Appl. No.: 14/792,761

(22) Filed: Jul. 7, 2015

Related U.S. Application Data
(60) Provisional application No. 62/183,565, filed on Jun. 23, 2015.

(51) Int. Cl. A47J 36/12

(52) U.S. Cl. CPC A47J 36/12

(57) ABSTRACT

Systems and method are disclosed for forming a holder adapted to be mounted to a container by using a continuous wire, forming first and second legs shaped to form a rim engaging portion to secure the holder to a container rim; first and second extension members extending from the first and second legs above the container; and first and second object contacting arms extending from the first and second extension members, wherein the legs, body portions and object contacting arms are formed using a single continuous wire; and suspending an object above the container with the object contacting arms.

This application claims priority to provisional application serial no. 62183565 filed Jun. 23, 2015, the content of which is incorporated by reference.

### BACKGROUND

This holder relates to an accessory holder for a pot or cooking appliance.

Cookware are types of food preparation devices found in most kitchens. Some of the most commonly used cookware are pots and pans. These objects are generally intended for use on a stove or oven top, but some may also be used in ovens, over open flames, and more. Pots and pans generally have a circular base and a top rim, however, pots tend to be deeper than pans, with higher sides that generally rise straight up, while pan sides usually taper outwards. Additionally, it is common for both devices to be used in conjunction with lids that are sized fit over their rims. While cooking, individuals often need to remove lids in order to check, stir, or add additional ingredients to their concoction. This becomes problematic as lids take up a lot of surface area and easily accumulate moisture, creating unwanted mess and spills. On top of this, walking back and forth between a stove and where the lid is placed can be time consuming and inefficient.

For example, when pot lids are removed from a cooking pot during or just after cooking, a hot pad is usually employed to engage the lid and to remove the same from the pot. A user may be dishing food out of the cooker or pot onto a plate, holding the plate with one hand and dishing food out of the slow cooker with the other. Consequently, both of the user's hands are occupied. The user is invariably confronted with a problem when reaching a pot with a lid covering the contents of the pot. The user can try to set his or her plate down, freeing one hand, remove the lid and set it aside, dish food out of the pot and onto his or her plate, then replace the lid. This is problematic, however, because typically there is insufficient space to set the lid aside. Alternatively, the user can ask his or her neighbor to hold the lid while they dish food out of the pot. Alternatively, the user can lay the hot pot lid aside on the stove or nearest kitchen counter top or table or other pots or pans. Often, the condensation of vapors developed during cooking and adhering to the cooking pot lid result in condensation on the lid lower surface which often drips onto the kitchen counter or table or pots or pans or sometimes on the floor. Also, the lids so haphazardly set aside were not readily available for use or reuse during cooking.

In light of the foregoing problems associated with pots and their removable lids, there remains a need for an accessory holder that alleviates or eliminates these problems.

### SUMMARY

In one aspect, a holder adapted to be mounted to a container and to hold an object above the container includes first and second legs shaped to form a rim engaging portion to secure the holder to a container rim; first and second extension members extending from the first and second legs above the container; and first and second object contacting arms extending from the first and second extension members, wherein the legs, body portions and object contacting arms are formed using a single continuous wire.

In another aspect, a method forms a holder adapted to be mounted to a container from a continuous wire. The method includes forming first and second legs shaped to form a rim engaging portion to secure the holder to a container rim; first and second extension members extending from the first and second legs above the container; and first and second object contacting arms extending from the first and second extension members, wherein the legs, body portions and object contacting arms are formed using a single continuous wire; and suspending an object above the container with the object contacting arms.

Implementations of the above aspects may include one or more of the following. The wire includes a metallic wire with a uniform cross section providing elastic deformation in conjunction with strength to support a predetermined weight. The first second legs are upside down J-shaped members forming curved or hooked portions. The J-shaped members are substantially parallel to each other and connected by a cross member at the end of each of the J-shape member's curved or hooked portions and wherein the first leg and second leg extend toward corresponding first and second extension members at the other ends of the J-shaped members. The cross member is straight and perpendicular to the first leg and second leg. When coupled to the container, the hooked portions of the J-shaped members are positioned on top of the rim, with straight portions of the J-shaped members being adjacent to the container's outer surface side wall, and wherein part or all of the cross member making contact with and being adjacent to the container's inner surface side wall. The length of the cross member is parallel to a base of the container when placed on a cooking surface. L-shaped first extension member and second extension member pieces that are parallel to each other, wherein each L-shape piece comprises a short portion and a long portion, wherein the first extension member is planar to the first leg and parallel to the second leg and the second extension member is planar to the second leg and parallel to the first leg. The first extension member and second extension member are perpendicular to the cross member. Acute bends connect ends of first and second extension members' short portions to ends of the first leg and second leg, respectively. The holder is attached to the container, the outer portions of the acute bends make contact with and press against the container's outer surface side wall. The first supporting arm and second supporting arm extend directly out of the first extension member's and second extension member's long portions. The holder is attached to a pot or pan, long portions of the first extension member and second extension member are generally be vertical or angled. The first supporting arm is planar to the second supporting arm. An obtuse bend to angle the first supporting arm and second supporting arm away from the rim engaging portion beginning at the ends of the first extension member's and second extension member's long portions about an axis parallel to the cross member. Portions of the first supporting arm and second supporting arm bend outwards and away from each other, with said portions remaining planar to each other and the supporting arms. Along the length of the holder, the first supporting arm and second supporting arm bend towards each other and, the first supporting arm and second supporting arm generally make contact with an outer surface of the container. The first holding bend and second holding bend are planar to each other, the first supporting arm, and the second supporting arm and wherein the first holding bend and second holding bend extend outwardly from the first supporting arm and second holding arm, respectively, and into the first end member and second end member and when the first holding bend and second holding bend are elastically deformed under tension to accept placement of a lid knob or a handle of a kitchen tool, wherein upon release, the first holding bend and second holding bend to move back towards a starting position and secure the object in place. The first supporting arm and second supporting arm are compressed or squeezed towards each other and inserted into a lid with a rectangular U-shaped handle, and upon release, the first supporting arm and second supporting arm move away from each other and push against an inner portion of a lid's rectangular U-shaped handle.

In another aspect, an apparatus for supporting a lid above a pot includes a lid support with a central body and an accessory holder coupled to one side of the central body to clip or snap fit the lid to the accessory holder. The apparatus also includes a pot rim support coupled to a second side of the central body to clip onto or snap fit the clip to a wall of the pot and anchor the apparatus to the pot.

Implementations of the above aspect may include one or more of the following. The anchor end will sit on any edge of the pot (any size). The adaptor to lid knob will attach to rectangular shaped or round shaped lid knob of any size. This allows the apparatus (Lidsitter) to attach to lid of any size. Once Lidsitter sits on edge of pot without any lid attached to to, it can hold scoops or large spoon. The design will allow to Lidsitter to stay attached to lid knob sturdily until removed. While attached to lid, the design will allow user to handle lid without touching lid at all.

The device can be used in an inverted manner where the previously described lid contacting portions contact the container, while the other end is used to suspend the lid. The inverted usage shows the flexibility of the holder where it works even when used in an inverted position where the rim engaging portion holds the lid, and the arms originally used to hold the lid is now used to provide physical support with the container outer wall.

Advantages of the system may include one or more of the following. The system provides a convenient holder for lids and auxiliary kitchen tools. The system, known as the, “Lidsitter,” is designed with a specific shape that grants users the ability to place lids, ladles, spoons, or other kitchen tools on the rim of a cooking pot, pan, or object alike. Without the system, such objects would have to be placed on surfaces nearby, taking up space, adding clutter, and requiring users to walk back and forth more while cooking. The Lidsitter will attach to the majority of lid knobs/handles currently available on lids of any size. The majority of lid knobs/handles are either rounded or rectangular. With minimal user manipulation, the Lidsitter would secure itself to the lid handle/knob. The shape of the device utilizes sufficient metallic tensile strength to wrap around the round lid knob or rectangular bracket at multiple contact points, due to compressional forces. Unless shaken with great force, the present holder will hold on tightly to the lid handle, serving as an adaptor to allow lids or other cooking tools to sit on the rim of a pot or pan in a sturdy manner. The Lidsitter allows users handle lids and scoops within reach. Kitchen of small size with would appreciate Lidsitter because it allows users to place lids and scoop/large spoons right on the edge of the pot. It allows user to not having to touch lid while it is hot. The design and material of Lidsitter will allow it to be used on lid/pot/stove that has flame where at times big flame could touch lid and could melt the plastic material.

The system allows cooking pot lids to be conveniently and readily stored with much less dripping and in the desired closeness to the cooking stove where the lids may be used and reused as cooking demands require. The cooking pot accessory holder device which can be mounted on the cooking stove and cooking area so that the lids can be conveniently placed or removed while cooking/dispensing as a particular recipe and cooking routine may require. Also, in small kitchens or where small counter top space is available, such as on boats, tractors, campers, and small kitchens, the utility of the holder becomes readily apparent. The accessory holder is attached to the pot or cooker appliance for supporting the lid thereof when the lid is removed from the pot or cooker. If a cooking pot lid is removed from a steaming pot or cooking appliance, the lid can be readily stored in the holder, thus substantially eliminating any dripping problem from moisture condensing from steam vapors created during the cooking procedure.

Various objects, advantages, and utilities of the holder will become apparent from the following description of my holder, taken in connection with the following drawings, wherein like reference numerals refer to like parts.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a cross-sectional view of an exemplary accessory holder in accordance with one embodiment;

FIG. 2 is a side view illustrating the accessory holder of FIG. 1 mounted on a pot, cooker, or appliance;

FIG. 3 is a cross-sectional view of a second exemplary accessory holder in accordance with a second embodiment; and

FIGS. 4A-4B are side views illustrating the accessory holder of FIG. 3 mounted on a pot, cooker, or appliance.

FIG. 5 is a perspective view of an exemplary holder device formed from a shaped wire, while FIG. 6 is an elevated front-side view of the device thereof;

FIG. 7 is an elevated top-side view of the device thereof;

FIG. 8 is an elevated top-side view of the device and a sleeve, with the first end member and second end member pinched together, before being inserted into the sleeve;

FIG. 9 is an elevated right-side view of the device thereof;

FIG. 10 is a perspective view of the device secured to a lid with a rectangular U-shaped handle;

FIG. 11 is a perspective view of the device secured to a lid knob; and

FIG. 12 is a perspective view of the device secured to a lid with a rectangular U-shaped handle and attached over the rim of a cooking pot.

### DESCRIPTION

All illustrations of the drawings are for the purpose of describing selected versions of the present invention and are not intended to limit the scope of the present invention. Embodiments are described more fully below with reference to the accompanying figures, which form a part hereof and show, by way of illustration, specific exemplary embodiments. These embodiments are disclosed in sufficient detail to enable those skilled in the art to practice the holder. However, embodiments may be implemented in many different forms and should not be construed as being limited to the embodiments set forth herein. The following detailed description is, therefore, not to be taken in a limiting sense in that the scope of the present invention is defined only by the appended claims.

In view of the aforementioned problem(s), the present holder is a holder for lids and auxiliary kitchen tools. The present holder is designed to allow users the ability to place lids belonging to pots or pans, ladles, spoons, or other kitchen tools on the rim of a cooking pot, pan, or object alike. Before explaining at least one embodiment of the present holder in detail, it is to be understood that the device is not limited in its application to the details of the components and arrangements as described or illustrated.

The holder is capable of other embodiments and of being utilized and carried out in various ways. It is also to be understood that the phrasing and terminology employed herein are for the purpose of description and should not be regarded as limiting. As such, the present holder is primarily used in kitchen or cooking environments, but the device may be applied to many other settings, situations, and scenarios.

In the preferred embodiment, the present holder is a holder, comprising a first end, a second end, a first end member, a second end member, a rim engaging portion, a first extension member, a second extension member, a first supporting arm, a second supporting arm, a first holding bend, and a second holding bend. The rim engaging portion further comprises a first leg, a second leg, and a cross member.

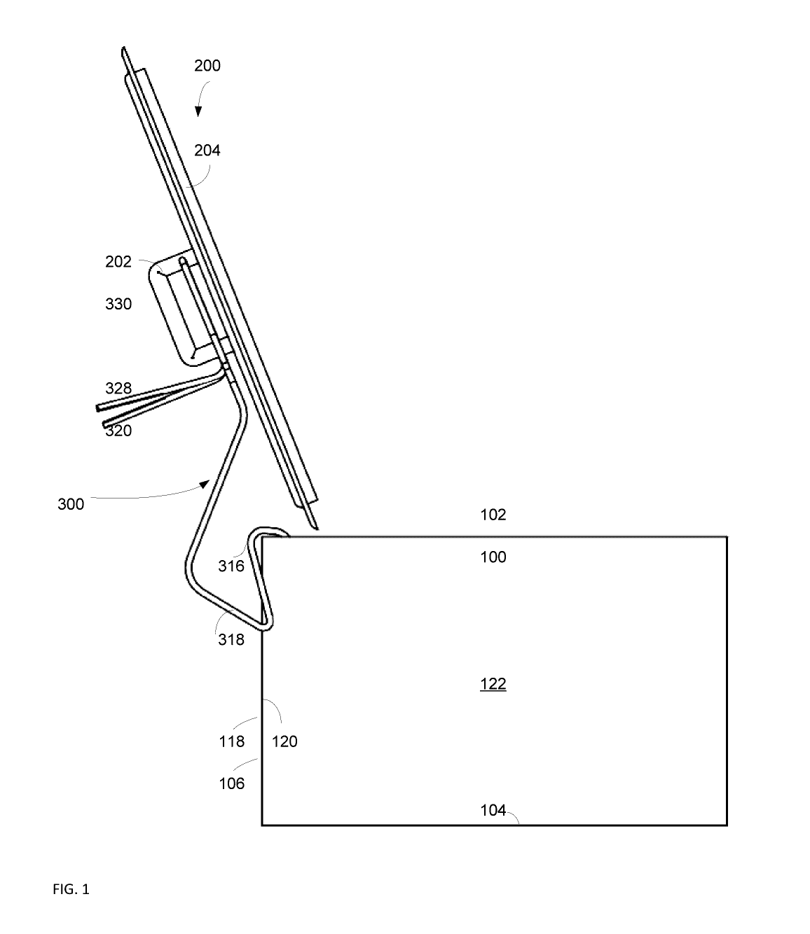

FIG. 1 shows a side elevation view of an exemplary accessory holder 300 in operation. In one embodiment, the accessory holder 300 is a wireframe with two bars with a predetermined shape to clip to the container 100 and to provide support for a lid 200. The numeral 100 refers to a container such as a pot, cooker or cooking appliance. Container 100 includes a housing 102 having a base or bottom 104 and a side wall 106 extending upwardly therefrom. Side wall 106 normally includes an outer side wall 108 and an inner side wall 120. For a slow cooker embodiment, a heating element may be enclosed in the base 104 as well as between the side walls 108 and 120. Base 104 and side wall 106 define a heating cavity having a rim adapted to receive a lid thereon. The container 100 receives the lid 200 with a handle or knob. The lid has an outer perimeter and a spaced lid rim which snugly fits with the rim of the container.

The holder 300 is adapted to be used with a hollow container 100 such as a pot, cooker or cooking appliance. The container 100 is typically rounded or cylindrical and of ceramic ware or metal, used for storage or cooking. The container 100 includes a housing with a base or bottom 104 and a side wall 106 extending upwardly therefrom. Side wall 106 normally includes an outer side wall 118 and an inner side wall 120. In case the container 100 is a cooker, a heating element is usually enclosed in the base 104 as well as between the side walls 108 and 120. Base 104 and side wall 106 define a heating cavity 122 having the lip or edge 102 adapted to receive a lid thereon. The pot 100 receives the lid 200 with a handle or knob 202. The lid 200 has an outer perimeter and a lid rim 204 which snugly fits with the edge 102.

The lid is generally designated at 200 has a handle 202 mounted on a generally circular plate 204. The lid 200 can be made of metal or can be made of a transparent material such as glass, for example. The lid 200 has a generally spherical surface and a threaded holes to secure the handle 202 to a lid plate.

As shown in FIG. 1, the lid 200 is suspended above the container 100 using the holder 300. The holder 300 has three major parts: a container contacting portion 310, a middle support portion 320, and a lid contacting portion 330. The container contacting portion 310 of the device 100 provides support for the lid 200. As shown in FIG. 1, the downwards vertical bars are braced against the outside of the container 100. The inner support bars 312 are braced against the inside of the pot 106. In tandem, these two support bars anchor and support the wireframe accessory holder 300 to the pot 100.

The appliance contacting section 330 can be used in a large variety of ways. An exemplary design is described in FIG. 1. The pot lid 200 is anchored to the pot 100 using the accessory holding apparatus 300. The pot lid handle 202 slides into the groove or receptacle 326 of the accessory holding device 300. The angle of the accessory contacting portion 330 keeps the pot lid 200 in place.

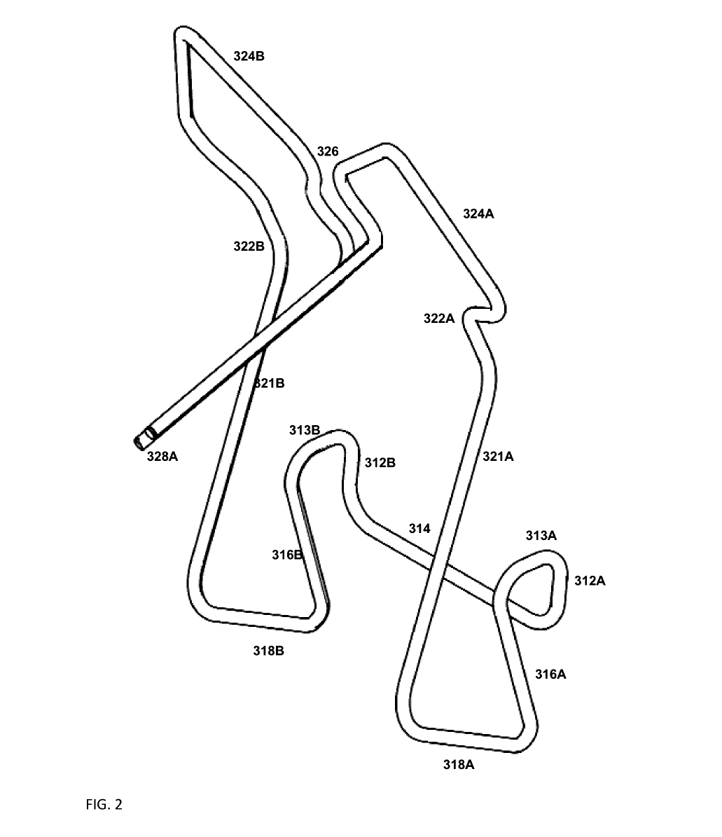

As best shown in FIG. 2, the container contacting portion 310 includes a bottom bar 314 that extends upwardly into side bars 312, each of which flattens into a top bar 313 whose width is sufficient to be clipped, mounted or otherwise secured to the container edge 102 and extends downwardly into container wall bars 316. Each container wall bar 316 eventually flattens out to form a horizontal extension bar 318. The bars 318 extend upwardly to form middle support portions 320. Together, the bars 312, 313, 314 and 316 secure the holder 300 to the container 100 as part of the container contacting portion 310.

The middle support portion 320 supports the lid contacting portion 330 above the hollow container 100, as secured by the container contacting portion 310. The middle support portion 320 is comprised of two parallel bars 321 extending upwards from the horizontal extension bars 318.

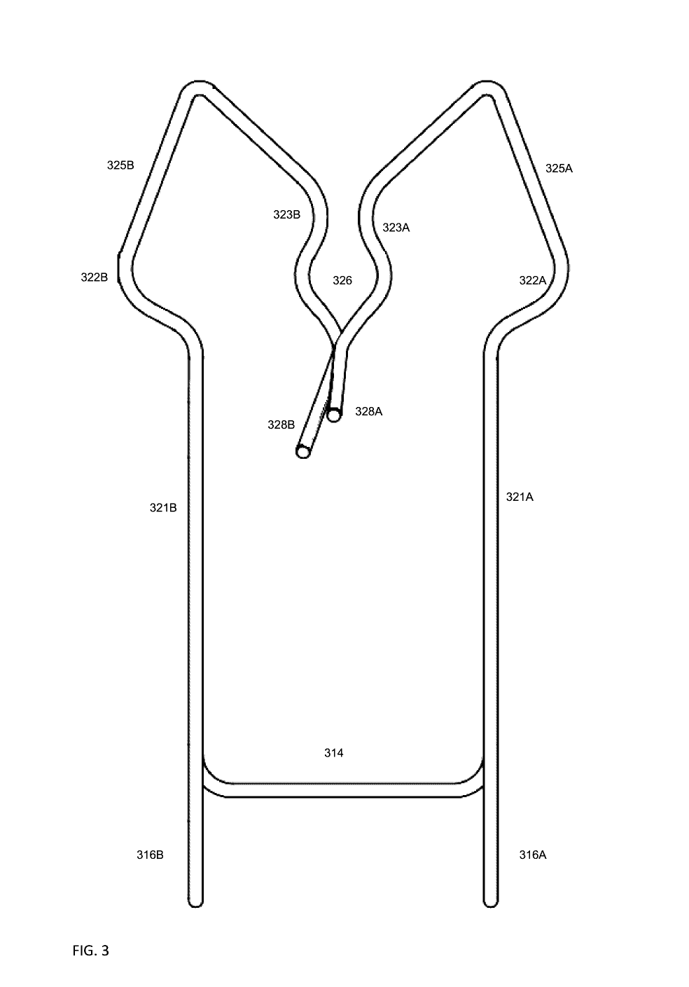

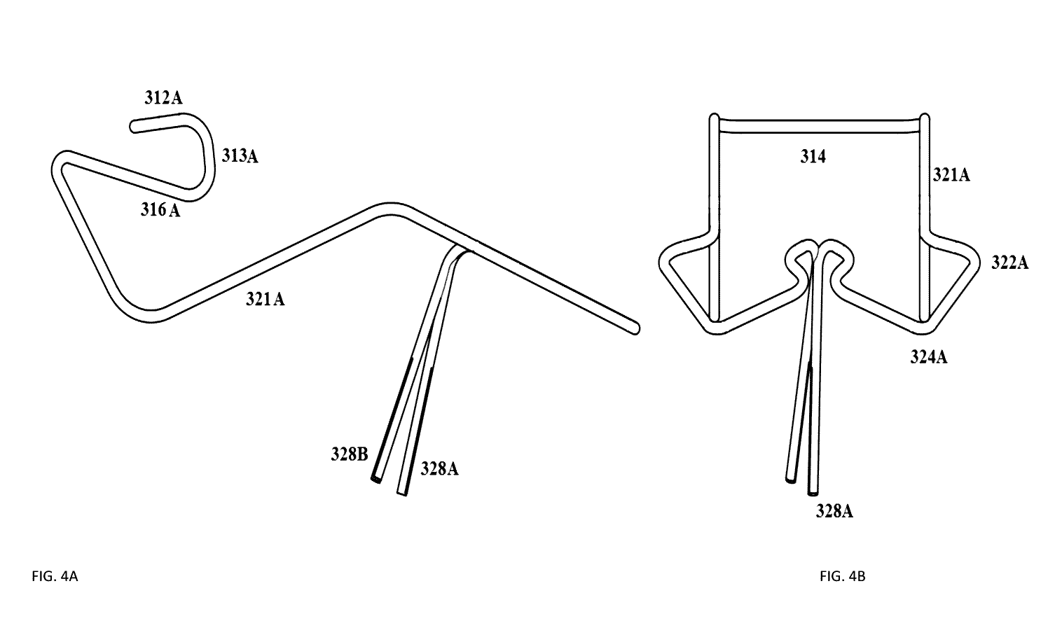

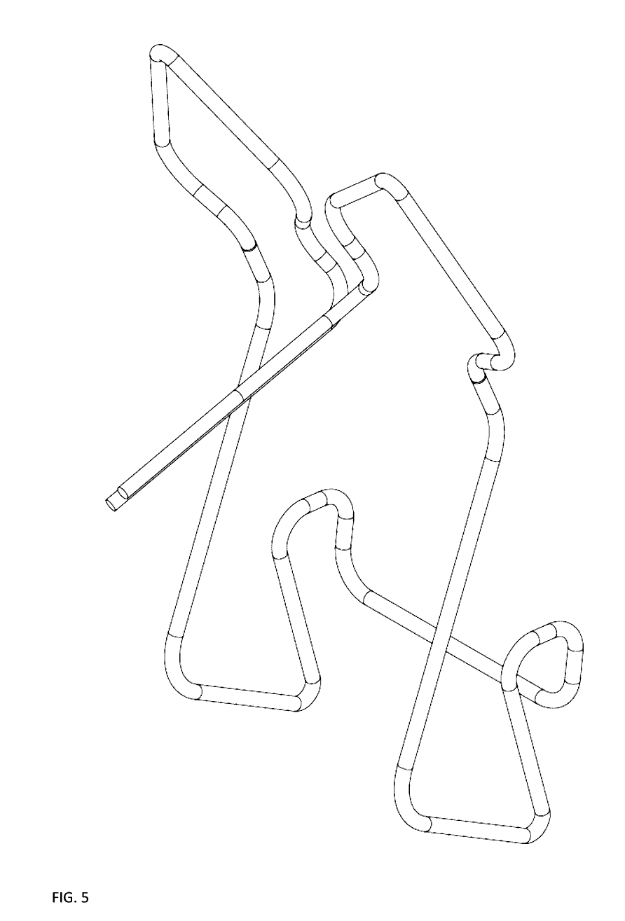

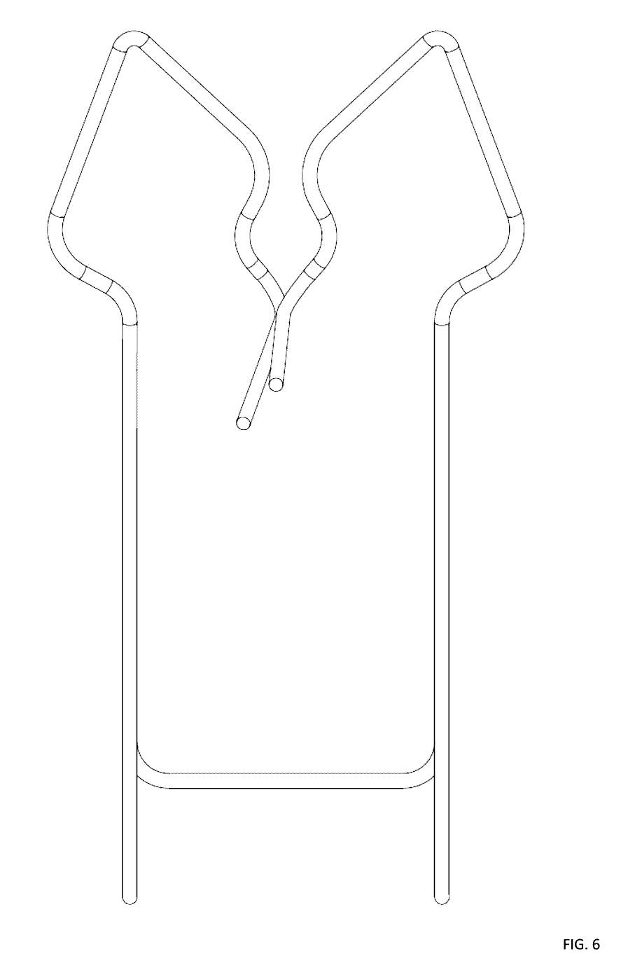

Viewing FIGS. 2 and FIG. 3 together, each bar 321A forms a V-shape kink 322 and then forms an arrowhead or spear-head shaped body 325. The corresponding remaining kinks 323A-323B of the arrowhead or spear-head shaped bodies 325A-325B collectively form an opening or receptacle 326 flexibly engages the lid handle or other utensils (such as a ladle, for example) as desired. The wire ends 328A-328B extend from the opening or receptacle 326. In one embodiment, a cover or handle can be inserted over the ends 328A-328B for ease of handling and heat isolation to the user's hand. The two ends 328 of the frame come together. These ends 328 are not attached in order to allow the wireframe body 300 to bend as needed. FIGS. 4-5 show side and front elevation views of the holder device 300.

In addition to holding the lid, the device 300 can hold other kitchen utensils. For example, the device 300 can suspend a ladle during cooking. As seen in FIG. 6, a soup ladle 400 is cradled by the accessory holding apparatus 300 rather than the lid 200 as previously shown in FIG. 1. Instead of lid handle 202 being cradled within the receptacle 326, soup ladle handle 402 is substituted. The ladle 302 can rest on the kinks 323A-323B of the arrowhead 326, or it can be secured within the receptacle 326.

Accessory holder was designed to allow user the ability to place lids or scoops/large spoons on the edge of the cooking pot. Without it, lid would have to be placed on surface of a nearby countertop table while the scoop or spoon placed directly into the pot or in a bowl also on a nearby flat surface. This obvious requires a lot of surface area and walking back and forth between the stove and the nearby counter top, and definitely entails the possibility of spilling while accessing lid/spoon/scoop.

The Accessory holder will attach to the majority of lid knob/handle currently available on the lid of any size. The majority of lid knob/handle is either rounded or rectangular. With minimal user manipulation, the Accessory holder would secure itself to the lid handle/knob. The design uses the metallic tensile strength to wrap around the round lid knob or bracket the rectangular lid knob at multiple contact points. Unless shaken with great force, the Accessory holder should hold on tightly to the lid handle serving as an adapter to allow lid to sit on the edge of a pot sturdily.

The Accessory holder could also be used as a rest/holder for large spoon/scoop. For rectangular lid handle/knob, one use scenario is as follows:
Place lid on a sturdy, flat surface
Use thumb and index finger to squeeze on the neck until the head is small enough to fir through the handle/knob.
Push the head through rectangular handle and release neck allowing accessory holder to grab onto rectangular lid handle by its tensile strength.
Once attached, the accessory holder is ready to be used as adapter to allow lid to sit on pot's edge.

For lid with round handle knob, one use scenario is as follows:
Place lid on a sturdy, flat surface
Create contact between head of Accessory holder and the neck of the lid knob.
Push Accessory holder forward toward the lid know to snap it into place.
Make sure Accessory holder head snaps tightly around the lid knob's neck.
Once attached, Accessory holder is ready to be used as adapter to allow lid to sit on pot's edge.

For Large spoon or scoops, one use scenario is as follows:
Place Accessory holder on the edge on the pot
Place hand of the large spoon/scoop in the space to hold the round lid knob.

Other uses
With additional adaptors, the Accessory holder can be used attach lid to the pot hollow rectangular handle. Lid then can opened or closed at a fixed angle to the pot handle. This is the case when Accessory holder does not sit on edge of the pot.
Large lid can also be attached to its pot hand in similar fashion with adapter sold separately.

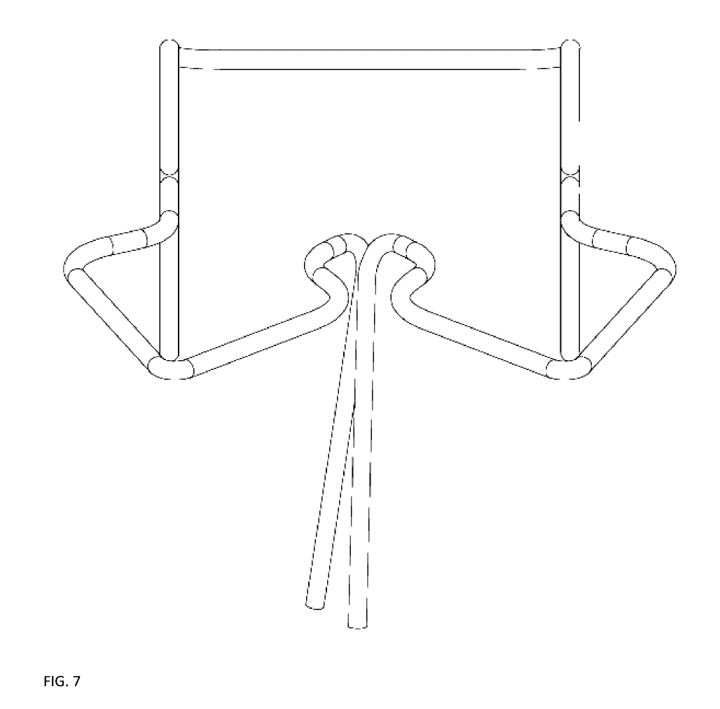

FIG. 5 is a perspective view of an exemplary holder device formed from a shaped wire, while FIG. 6 is an elevated front-side view of the device thereof and FIG. 7 is an elevated top-side view of the device thereof. In one embodiment, the holder is a single continuous metallic wire, with a uniform cross section and a substantially high tensile strength, allowing for elastic deformation in conjunction with high strength, enough to support several pounds of weight. The cross sectional shape of throughout the holder is generally circular, however, this may vary. Other possible shapes may include but are not limited to ovular, rectangular, triangular, etc. The present holder is shaped to retrofit onto the rim of just about any cooking pot or pan. The shape allows users to attach almost any lid knob or lid handle belonging to a cooking pot or pan to the present holder itself. Such lid knobs comprise cylindrical necks that taper outwards and such lid handles are those of the rectangular U-shaped type, with each end of the rectangular U-shape being attached to the outer top surface of the lid. Additionally, the present holder may be used as a holder for auxiliary cooking tools that may include but are not limited to ladles, stirring spoons, potato mashers, egg whisks, and more. For the purpose of simplicity, cooking pots and pans may be referenced interchangeably.

In the preferred embodiment, the rim engaging portion retrofits/slips over or onto the rim of a cooking pot, functioning as a means of attachment for the holder to the pot. The first leg and second leg are upside down J-shaped members that are parallel to each other and connected by the cross member, at the end of each of the J-shape's curved or hooked portions. The first leg and second leg extend directly into the first extension member and second member, at the other ends of the aforementioned J-shapes, respectively. The cross member is straight and perpendicular to the first leg and second leg. When attached to a pot, the hooked portions of the aforementioned J-shapes sit on top of the rim, with the straight portions of the aforementioned J-shapes being adjacent to the pot's outer surface side wall, by the first extension member and second extension member, and with part or all of the cross member making contact with and being adjacent to the pot's inner surface side wall. As well, it can be seen that the length of the cross member is parallel to a base of the pot, which is flat and parallel to a stove top.

In the preferred holder, the first extension member and second extension member extend are L-shaped pieces that are parallel to each other. Each L-shape comprises a short portion and a long portion. The first extension member is planar to the first leg and parallel to the second leg. The second extension member is planar to the second leg and parallel to the first leg. The first extension member and second extension member are perpendicular to the cross member. Acute bends connect ends of first member's and second member's short portions to ends of the first leg and second leg, respectively. The first supporting arm and second supporting arm extend directly out of the first extension member's and second extension member's long portions, respectively. When the holder is attached to a pot or pan, the long portions of the first extension member and second extension member will generally be vertical, however, it may also be angled. Additionally, when the holder is attached to a pot or pan, the outer portion of the aforementioned acute bends will make contact with and press against the pot's outer surface side wall.

In the embodiment, the first supporting arm is planar to the second supporting arm. Beginning at the ends of the first extension member's and second extension member's long portions, obtuse bends exist, angling the first supporting arm and second supporting arm away from the rim engaging portion, about an axis parallel to the cross member. Past this, portions of the first supporting arm and second supporting arm bend outwards and away from each other, with said portions still remaining planar to each other as well as the supporting arms. Continuing along the length of the device, the first supporting arm and second supporting arm bend inwards and towards each other. For further reference, the shape of the first supporting arm and second supporting arm may be seen in FIGS. 1-4. As such, the first supporting arm and second supporting arm will generally make direct contact with the main outer surface of a pot or pan's lid or portions of other kitchen tools, whilst a lid or other kitchen tool is secured to the holder. With this, the first supporting arm and second supporting arm function to brace the object being held.

In one embodiment, the first holding bend and second holding bend are planar to each other, the first supporting arm, and the second supporting arm. The first holding bend and second holding bend extend directly out of the first supporting arm and second holding arm, respectively, and directly into the first end member and second end member, respectively. The first holding bend and second holding bend are positioned and shaped, forming a small space in between. When the first holding bend and second holding bend are elastically deformed, in a manner to which they are pulled apart and away from each other under tension, the aforementioned space in between them increases, allowing for placement of a lid knob, belonging to a pot or the handle of a kitchen tool. Upon release, the mechanical properties of the holder will cause the first holding bend and second holding bend to move back towards their starting position, securing the held object in place. Additionally, the first supporting arm and second supporting arm may be compressed or squeezed towards each other and inserted into a lid's rectangular U-shaped handled. Upon releasing the compressional forces, the first supporting arm and second supporting arm will move away from each other, back towards their starting position, pushing against the inner portion of the lid's rectangular U-shaped handle. With this, the lid and rectangular U-shaped handle will rest securely against the holder. In this position, the first end member and second member are shaped and positioned to catch the held device, if it were to slip out of position.

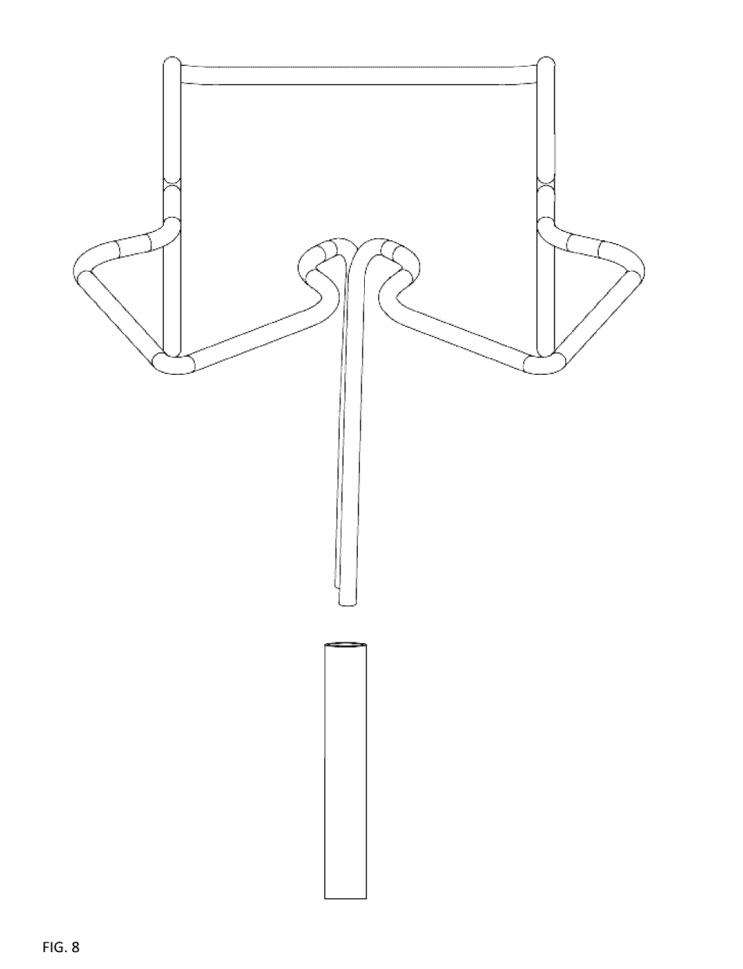

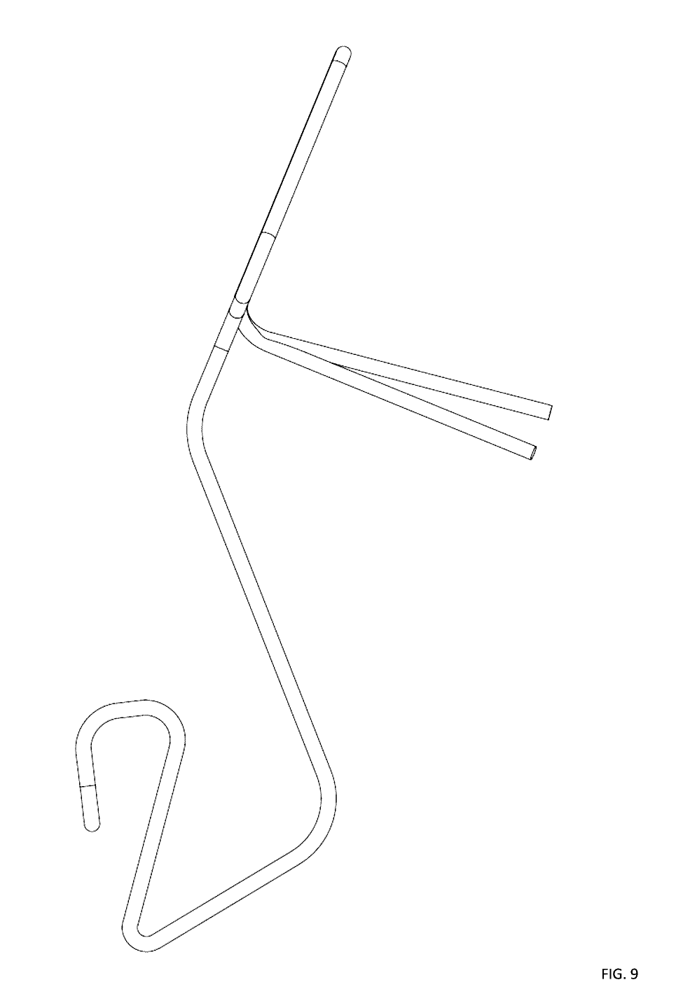

FIG. 8 is an elevated top-side view of the device and a sleeve, with the first end member and second end member pinched together, before being inserted into a sleeve; and FIG. 9 is an elevated right-side view of the device thereof.

In another embodiment, the first end member and second end member are direct extensions of the first holding bend and second holding bend, respectively. The first end member and second end member extend up to the first end and second end, respectively. The first end member and second end member are generally straight or slightly curved, being roughly perpendicular to the first holding bend, second holding bend, first supporting arm, and second supporting arm, however, this may vary. With reference to FIG. 8, when attached over the rim of a pot or pan, it can be seen that the first end member and second end member extend in a direction away from the pot or pan. With reference to FIG. 4 and FIGS. 6-8, the first end member and second end member may be pinched or squeezed together and inserted into a sleeve or sheath device. The sleeve is a flexible cylindrical piece with a through hole extending between both ends. The sleeve or sheath device is dimensioned to snuggly receive the first end member and second end member, preventing the distance between them from increasing, as well as the distance between the first holding bend and second holding bend. As such, the sleeve or sheath device provides additional compressional forces, preventing the object being support by the holder from slipping out of position in unwanted circumstances.

In alternative embodiments of the holder, the cross sectional shape and dimensions may vary throughout the length of the object. As well, the shape may vary. These changes may occur as long as the scope and objective of the present holder remains unchanged.

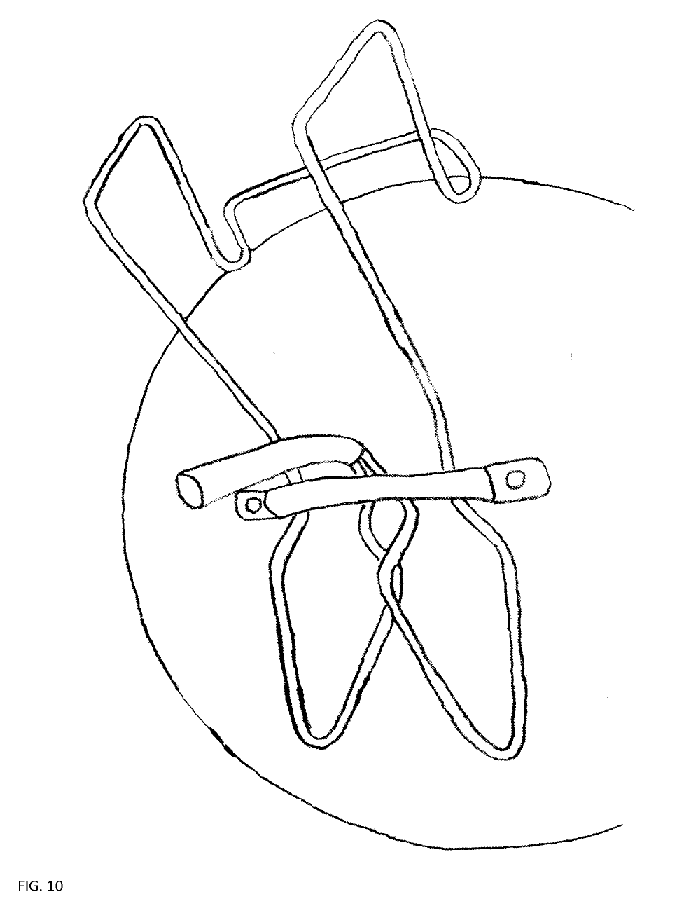

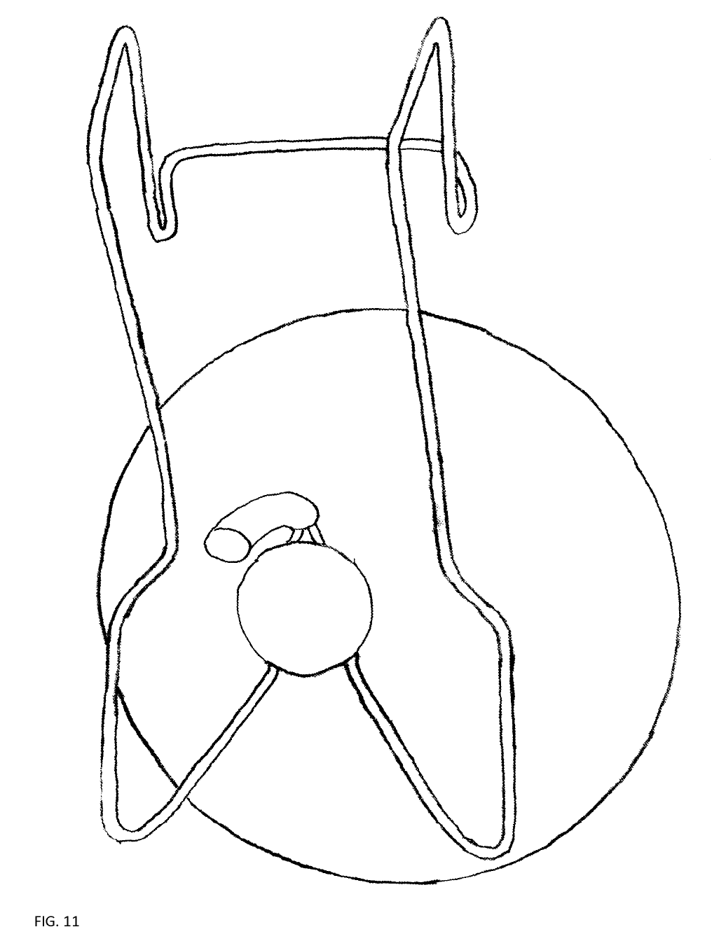

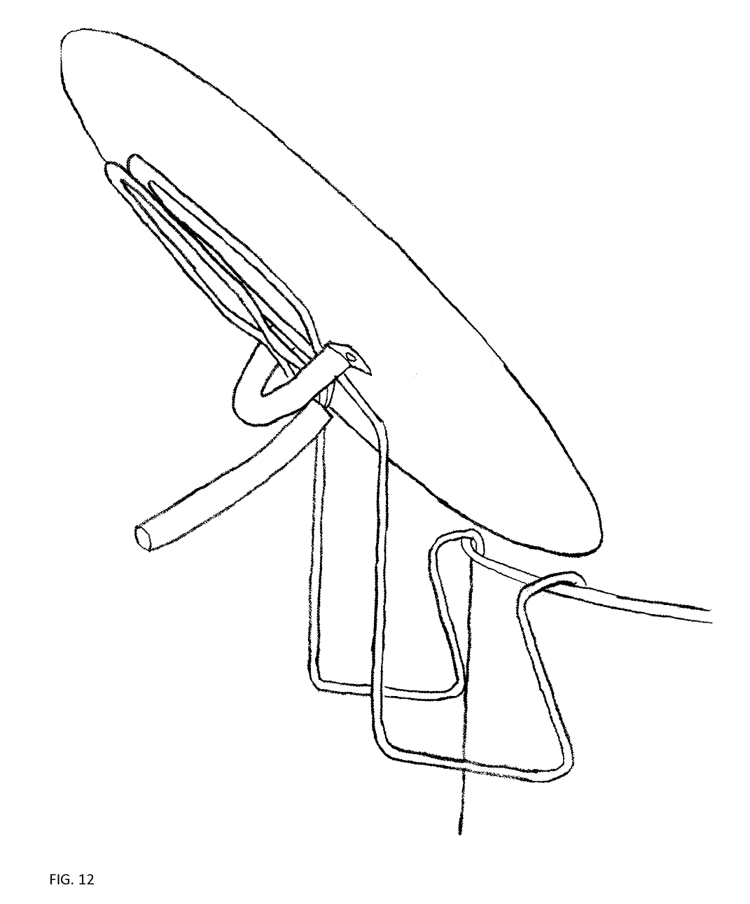

FIG. 10 is a perspective view of the device secured to a lid with a rectangular U-shaped handle; FIG. 11 is a perspective view of the device secured to a lid knob; and FIG. 12 is a perspective view of the device secured to a lid with a rectangular U-shaped handle and attached over the rim of a cooking pot.

In one embodiment where the holder is a solid shape instead of a wire frame, the holder includes a pot clipping portion with two prongs forming an inverted, generally U-shaped clip secured against surfaces of the pot, respectively. The prongs are connected to an optional horizontal middle body that extends vertically as an arm. The arm has two prongs touching the outer surface of the lid to form another inverted, generally U-shaped clip for securing the knob. In one embodiment, the prongs are elastic or springy sufficient to snap-fit with the knob to tightly hold the knob 48 to the accessory holder. In other embodiments, the prongs provide a loose fit to retain the knob 48 for ease of removal.

The accessory holder is used as follows: when the lid is to be removed, the accessory holder is inserted onto the upper rim of side wall by positioning the clip over the upper rim with the lower prongs or support members being positioned outwardly of the exterior surface of side wall and being in engagement therewith. The lid can then be placed on prongs. The prongs or support members form an anchor end that will sit on any edge of the pot (any size). The adaptor to lid knob will attach to rectangular shaped or round shaped lid knob of any size. This allows Lidsitter to attach to lid of any size. Once Lidsitter sits on edge of pot without any lid attached, it can hold scoops or large spoon. The design will allow to Lidsitter to stay attached to lid knob sturdily until removed. While attached to lid, the design will allow user to handle lid without touching lid at all. The Lidsitter allows users handle lids and scoops within reach. Kitchen of small size with would appreciate Lidsitter because it allows users to place lids and scoop/large spoons right on the edge of the pot. It allows user to not having to touch lid while it is hot. The design and material of Lidsitter will allow it to be used on lid/pot/stove that has flame where at times big flame could touch lid and could melt plastic accessory holders out there.

When the cook wishes to stir the contents in container, the cook grasps the handle or knob of lid and places the lid on the accessory holder. The lid is supported by the accessory holder by placing the knob into the prongs so that the interior surface of lid is facing the cooker. In such a position, the lid is also supported by the engagement thereof with the upper support member. In its held position, the lower interior end of the lid will be positioned slightly above the lid receiving body so that any condensation draining from the lid will drain back into the interior of the cooking container. The accessory holder provides a convenient and safe means for holding the lid during the times when the lid is removed from the cooking container.

In another embodiment, the clip uses a double spring arrangement to engage and hold the handle 48 of pot lids over a wide variation in diameter, compared to spring member which is a single spring as distinguished from a double spring. Typical spring clips are self-retaining, one-piece fasteners that slip into a mounting hole or onto a flange or panel edge. Secondary fastening devices such as rivets, studs, or screws are not needed because the clips are held by spring tension and do not loosen easily through vibration. Varied spring tensions are obtained by controlling the width and thickness of the steel. Some other metals are used but cannot match the spring properties of high-carbon steel. Plastic fasteners have replaced metal spring clips in many applications. However, plastic designs are limited by their holding capabilities and by some environmental conditions. Many plastic clamps and fasteners are self-retained to panels by an integral dart shape, an expandable leg, or high-strength contact adhesive. Dart-shaped, panel-retaining spring clips have “hips” to engage within panel or component holes. They are commonly used to join two panel surfaces, as in refrigerator door liners. Other configurations are used to fasten cables, molding trim, gaskets, and fabrics. Most dart-type clips are easily removable and require a mounting hole and space behind the mounting panel to accommodate the part. They may be installed with finger pressure for light duty or with power tools for heavy applications

In another embodiment, the holder can use a clip with a double spring arrangement to engage and hold the handle of pot lids over a wide variation in diameter, compared to spring member which is a single spring as distinguished from a double spring. Typical spring clips are self-retaining, one-piece fasteners that slip into a mounting hole or onto a flange or panel edge. Secondary fastening devices such as rivets, studs, or screws are not needed because the clips are held by spring tension and do not loosen easily through vibration. Varied spring tensions are obtained by controlling the width and thickness of the steel. Some other metals are used but cannot match the spring properties of high-carbon steel. Plastic fasteners have replaced metal spring clips in many applications. However, plastic designs are limited by their holding capabilities and by some environmental conditions. Many plastic clamps and fasteners are self-retained to panels by an integral dart shape, an expandable leg, or high-strength contact adhesive. Dart-shaped, panel-retaining spring clips have “hips” to engage within panel or component holes. They are commonly used to join two panel surfaces, as in refrigerator door liners. Other configurations are used to fasten cables, molding trim, gaskets, and fabrics. Most dart-type clips are easily removable and require a mounting hole and space behind the mounting panel to accommodate the dart. They may be installed with finger pressure for light duty or with power tools for heavy applications.

Although particular features are shown or described with respect to particular embodiments disclosed herein, it will be appreciated that these features can be combined with the features or substituted for the features of other embodiments. The skilled artisan will appreciate that other substitutions and combinations can be made.

The above disclosure is intended to be illustrative and not exhaustive. This description will suggest many variations and alternatives to one of ordinary skill in this field of art. All these alternatives and variations are intended to be included within the scope of the claims where the term “comprising” means “including, but not limited to.” Those familiar with the art may recognize other equivalents to the specific embodiments described herein which equivalents are also intended to be encompassed by the claims.

Further, the particular features presented in the dependent claims can be combined with each other in other manners within the scope of the holder such that the holder should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the holder. Those skilled in the art may recognize other equivalents to the specific embodiment described herein which equivalents are intended to be encompassed by the claims attached hereto.

Changes may be made in the forms, dimensions, and arrangements of the parts of the cooking accessory holder without departing from the principle thereof as defined in the following claims.

Although the holder has been described in language that is specific to certain structures and methodological steps, it is to be understood that the holder defined in the appended claims is not necessarily limited to the specific structures and/or steps described. Rather, the specific aspects and steps are described as forms of implementing the claimed holder. Since many embodiments of the holder can be practiced without departing from the spirit and scope of the holder, the holder resides in the claims hereinafter appended.

Although the invention has been explained in relation to its preferred embodiment, it is to be understood that many other possible modifications and variations can be made without departing from the spirit of the scope of the holder.

What is claimed is:

1. A holder adapted to be mounted to a container and to hold an object above the container, comprising:
first and second legs shaped to form a rim engaging portion to secure the holder to a container rim;
first and second extension members extending from the first and second legs above the container; and
first and second object contacting arms extending from the first and second extension members, wherein the legs, body portions and object contacting arms are formed using a single continuous wire.

2. The holder of claim 1, wherein the wire comprises a metallic wire with a uniform cross section providing elastic deformation in conjunction with strength to support a predetermined weight.

3. The holder of claim 1, wherein the first second legs are upside down J-shaped members forming curved or hooked portions.

4. The holder of claim 3, wherein the J-shaped members are substantially parallel to each other and connected by a cross member at the end of each of the J-shape member's curved or hooked portions and wherein the first leg and second leg extend toward corresponding first and second extension members at the other ends of the J-shaped members.

5. The holder of claim 4, wherein the cross member is straight and perpendicular to the first leg and second leg.

6. The holder of claim 4, when coupled to the container, the hooked portions of the J-shaped members are positioned on top of the rim, with straight portions of the J-shaped members being adjacent to the container's outer surface side wall, and wherein part or all of the cross member making contact with and being adjacent to the container's inner surface side wall.

7. The holder of claim 1, wherein the length of the cross member is parallel to a base of the container when placed on a cooking surface.

8. The holder of claim 1, comprising L-shaped first extension member and second extension member pieces that are parallel to each other, wherein each L-shape piece comprises a short portion and a long portion, wherein the first extension member is planar to the first leg and parallel to the second leg and the second extension member is planar to the second leg and parallel to the first leg.

9. The holder of claim 1, wherein the first extension member and second extension member are perpendicular to the cross member.

10. The holder of claim 1, comprising acute bends connecting ends of first and second extension members' short portions to ends of the first leg and second leg, respectively.

11. The holder of claim 10, when the holder is attached to the container, the outer portions of the acute bends make contact with and press against the container's outer surface side wall.

12. The holder of claim 1, wherein the first supporting arm and second supporting arm extend directly out of the first extension member's and second extension member's long portions.

13. The holder of claim 1, wherein when the holder is attached to a pot or pan, long portions of the first extension member and second extension member are generally be vertical or angled.

14. The holder of claim 12, wherein the first supporting arm is planar to the second supporting arm.

15. The holder of claim 1, comprising an obtuse bend to angle the first supporting arm and second supporting arm away from the rim engaging portion beginning at the ends of the first extension member's and second extension member's long portions about an axis parallel to the cross member.

16. The holder of claim 1, wherein portions of the first supporting arm and second supporting arm bend outwards and away from each other, with said portions remaining planar to each other and the supporting arms.

17. The holder of claim 1, wherein along the length of the holder, the first supporting arm and second supporting arm bend towards each other and, the first supporting arm and second supporting arm generally make contact with an outer surface of the container.

18. The holder of claim 1, wherein the first holding bend and second holding bend are planar to each other, the first supporting arm, and the second supporting arm and wherein the first holding bend and second holding bend extend outwardly from the first supporting arm and second holding arm, respectively, and into the first end member and second end member and when the first holding bend and second holding bend are elastically deformed under tension to accept placement of a lid knob or a handle of a kitchen tool, wherein upon release, the first holding bend and second holding bend to move back towards a starting position and secure the object in place.

19. The holder of claim 1, wherein the first supporting arm and second supporting arm are compressed or squeezed towards each other and inserted into a lid with a rectangular U-shaped handle, and upon release, the first supporting arm and second supporting arm move away from each other and push against an inner portion of a lid's rectangular U-shaped handle.

20. A method for forming a holder adapted to be mounted to a container, comprising:
from a continuous wire, forming first and second legs shaped to form a rim engaging portion to secure the holder to a container rim; first and second extension members extending from the first and second legs above the container; and first and second object contacting arms extending from the first and second extension members, wherein the legs, body portions and object contacting arms are formed using a single continuous wire; and
suspending an object above the container with the object contacting arms.
